(19) United States
(12) Patent Application Publication
(10) Pub. No.: US 2008/0039101 A1
(43) Pub. Date: Feb. 14, 2008

(54) METHOD AND APPARATUS FOR COMMUNICATION BY A SECONDARY USER OF SPECTRUM

(75) Inventor: Edgar H. Callaway, Boca Raton, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/463,810

(22) Filed: Aug. 10, 2006

(51) Int. Cl. H04Q 7/20

(52) U.S. Cl. 455/445

(57) ABSTRACT

A method and apparatus is provided for allowing communication of a secondary communication device over spectrum allocated to a primary user. During operation a node wishing to communicate will determine a route to a destination device that will cause a least amount of interference to a primary communication system. Communication will then take place only if the sum of all communications along the route will not cause interference to the primary communication system.

### FIELD OF THE INVENTION

The present invention relates generally to wireless communications, and in particular, to a method and apparatus for communication by a secondary user of spectrum.

### BACKGROUND OF THE INVENTION

In a cognitive radio (CR) system of the type considered for use by IEEE 802.22, a cognitive secondary radio system will utilize spectrum assigned to a primary system using an opportunistic approach. With this approach, the secondary radio system will share the spectrum with primary incumbents as well as those operating under authorization on a secondary basis. Under these conditions, it is imperative that any user in the cognitive radio system not interfere with primary users. Some types of cognitive radio systems (e.g., IEEE 802.22) require that devices sense the channel to detect a licensed, primary user. The devices are allowed to transmit if their transmissions will not interfere with any primary user. This is generally accomplished by the secondary user determining a signal strength of the primary users, and if the signal of any primary user is above a predetermined threshold, the cognitive radio device determines that its transmissions would cause interference to the primary user, and so inhibits transmission.

When only a few devices are present, this scheme works well. However, as the transmit activity of the devices increases, and as the number of devices increases (i.e., as the network becomes more dense), their transmit power adds non-coherently and may rise to a level that causes interference to the primary user, even though a single CR device may not cause interference. To avoid this, a need exists for a method and apparatus for allowing communication over secondary spectrum that avoids interfering with the primary user when transmissions from multiple devices will add to cause interference.

### BRIEF DESCRIPTION OF THE DRAWINGS

FIG. 1 is a block diagram showing a primary and secondary communication system.

FIG. 2 and FIG. 3 illustrate route formation within an ad-hoc communication system.

FIG. 4 is a block diagram of a node.

FIG. 5 is a flow chart showing the operation of a node of FIG. 2 when acting as an originating or source node.

FIG. 6 is a flow chart showing the operation of a node of FIG. 2 when acting as a relay or a destination node.

### DETAILED DESCRIPTION OF THE DRAWINGS

To address the above-mentioned need a method and apparatus is provided for allowing communication of a secondary communication device over spectrum allocated to a primary user. During operation a node wishing to communicate will determine a route to a destination device that will cause a least amount of interference to a primary communication system. Communication will then take place only if the sum of all communications along the route will not cause interference to the primary communication system.

The present invention encompasses a method for communicating by a secondary communication device over spectrum utilized by a primary communication device. The method comprises the steps of selecting a best route to utilize based on a function of intervening nodes' distance to a primary communication device and/or signal-strength measurements of the primary communication device. The best route is then utilized to transmit information to the destination node.

The present invention encompasses a method for communicating by a secondary communication device over spectrum utilized by a primary communication device. The method comprises the steps of determining at least one route to a destination node using a cost, wherein the cost of the route is a function of intervening nodes' signal-strength measurements of a primary communication device. A route to the destination node having a least cost is then utilized.

The present invention additionally encompasses a method comprising the steps of receiving a route reply (RREP) message, wherein the route reply message comprises a cost for a route, and wherein the cost for the route is a function of intervening nodes' signal-strength measurements of a primary spectrum user. A signal strength measurement of the primary spectrum user is determined and the cost of the route is modified based on the signal strength measurement of the primary spectrum user. The modified RREP message is then forwarded.

The present invention additionally encompasses an apparatus comprising logic circuitry determining at least one route to a destination node using a cost, wherein the cost of the route is a function of intervening nodes' signal-strength measurements of a primary communication device. A transmitter is provided for utilizing a route to the destination node having a least cost.

The present invention additionally encompasses an apparatus for communicating by a secondary communication device over spectrum utilized by a primary communication device. The apparatus comprises logic circuitry selecting a best route to utilize based on a function of intervening nodes' distance to a primary communication device and/or signal-strength measurements of the primary communication device, and a transmitter utilizing the best route to transmit information to the destination node.

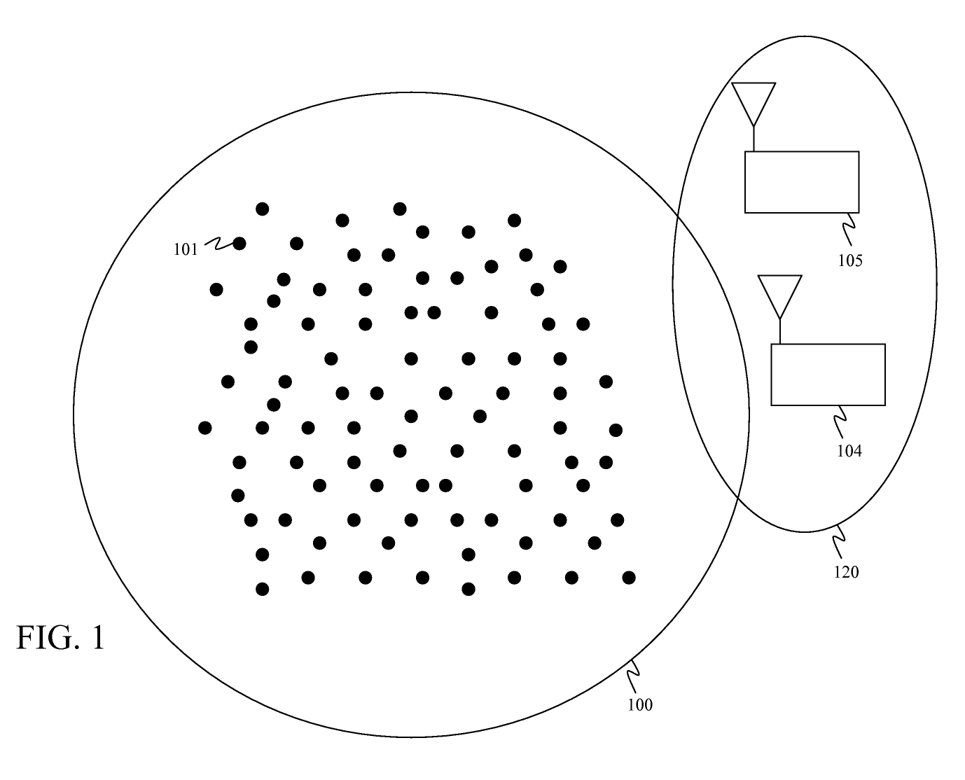

Turning now to the drawings, wherein like numerals designate like components, FIG. 1 illustrates a primary and secondary communication system sharing the same spectrum. Secondary communication system preferably comprises an ad-hoc communication system utilizing the IEEE 802.22 communication system protocol that is modified to perform the functionality set forth below. However, in alternate embodiments of the present invention, communication system 100 may comprise any ad-hoc or non ad-hoc communication system, such as, but not limited to a neuRFon™ communication system, available from Motorola, Inc., a WLAN network typically utilizing IEEE 802.11b ad hoc networking protocols or RoofTop™ Wireless Routing mesh network manufactured by Nokia, Inc. As shown, communication system 100 comprises plurality of nodes 101 (only one labeled). Plurality of nodes 101 form a communication network, with each node 101 capable of short-range communication to neighboring nodes only.

Primary communication system 120 is also shown in FIG. 1 operating in a same geographic area as secondary communication system 100. Primary communication system 120 comprises a plurality of transceivers 104-105 that are capable of over-the-air communication.

As one of ordinary skill in the art will recognize, transmissions between two nodes within communication system 100 generally take place through intervening nodes, with the intervening nodes receiving a source transmission, and relaying the source transmission until the source transmission reaches its destination node. Thus, a first node, wishing to transmit information to a second node, must first determine a route (i.e., those intervening nodes) between the first and the second node. In a preferred embodiment of the present invention a cost-based routing algorithm (e.g., the Ad hoc On-Demand Distance Vector (AODV) algorithm) is utilized to determine a route between a source and a destination node. As discussed in the Internet Engineering Task Force (IETF) RFC [Request for Comments] 3561, the Ad hoc On-Demand Distance Vector (AODV) algorithm enables dynamic, self-starting, multi-hop routing between participating mobile nodes wishing to establish and maintain an ad hoc network.

During route formation a “hop count” is determined and a route with a lowest “hop count” is utilized. It is realized that there are other “cost” metrics one could use besides hop count. Examples where cost-based routing is described are Kai-Wei Ke and Chin-Tan Lea, “On cost-based routing in connection-oriented broadband networks,” Proc. Global Telecommunications Conference, vol. 2, 1999, pp. 1522-1526, and Jian Chu, Chin-Tau Lea, and Albert Wong, “Cost-based QoS routing,” Proc. 12th Intl. Conf. Computer Communication and Networks, 20-22 Oct. 2003, pp. 485-490.

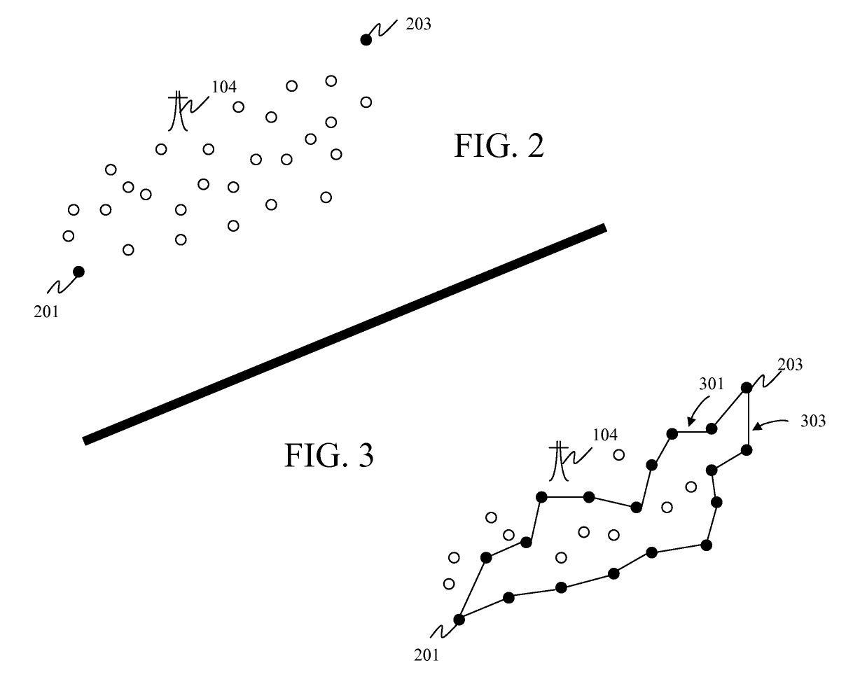

As a secondary communication system, communication system 100 will utilize spectrum assigned to a primary system 120 using an opportunistic approach. With this approach, the secondary radio system 100 will share the spectrum with primary incumbents as well as those operating under authorization on a secondary basis. Under these conditions, it is imperative that any user in the cognitive radio system 100 not interfere with primary users. In order to address this issue, during operation, a node wishing to communicate will determine a route to a destination device that will result in a least “cost”. In this case, “cost” comprises an amount of interference to a primary communication system. Communication will then take place utilizing the route with the least cost, only if the sum of all communications along the route will not cause interference to the primary communication system. This is illustrated in FIG. 2 and FIG. 3.

FIG. 2 and FIG. 3 illustrate route formation within a secondary communication system. With respect to FIG. 2, assume node 201 wishes to communicate with node 203. Because nodes 201 and 203 are capable of short-range communications only, a path (or route) of intervening nodes must be chosen to relay communications between nodes 201 and 203. Assume that communication unit 104 is a primary user of the spectrum. FIG. 3 illustrates two possible paths between nodes 201 and 203. As is evident, path 301 will pass much closer to primary user 104 than will path 303. Because of this, path 301 may cause more interference with node 104 than will path 303. Communication will then take place along path 303 only if the sum of all communications along the route will not cause interference to the primary communication system.

### Route Discovery and Determining a Cost of a Route:

Cost-based routing schemes employ routing tables in each network node, indexed by destination node address. In each entry in the routing table, the address of the “next hop,” or next relay node, is given, along with the cost of routing the message to the destination via that relay node. (A node's own address is always in the routing table, with a routing cost of zero.) If a node possesses a message for transmission, it searches its routing table for the entry of the destination node and the cost of utilizing the route. If the entry exists, the node sends the message to the relay node indicated in the table. However, if a source node has a message for a destination node, but does not have an entry for that destination node in its routing table, the route from source node to destination node must be discovered before the message can be sent.

To accomplish this, the source node broadcasts a “Route Request” (RREQ) message to all nodes in the network. The RREQ message contains the address of the source node and the address of the destination node. Network nodes that receive the RREQ message rebroadcast it if they do not have an entry for the destination node in their routing tables. If they do have an entry, however, they send/create a “Route Reply” (RREP) message to the source node, listing a cost of forwarding the message to its destination via that node (a value found in their routing table, but subject to being updated before transmission). As discussed, the cost of forwarding the message comprises a sum of all signal-strength measurements of a primary node for all relaying nodes. In other words, the cost of forwarding a message comprises the summed signal strength measurements as perceived by all intervening, or relaying nodes.

Any node creating or relaying a RREP message to the source node will add their incremental routing cost to the value in the RREP they receive, and then forward the modified RREP message, with a new cost value, on the route back to the source node. They also update their routing tables with an entry for the destination node. When the RREP message reaches the source node, the message contains a total cost for that route (i.e., a sum of all signal strength measurements). Should multiple RREP messages be received (due to multiple competing routes), the source node examines the message with the least cost, and inserts that cost, plus the address of the last relaying node of that message, into its routing table, linked to the destination node address. The source node now has a least-cost routing table entry for the destination node, and can send messages to it.

Cost-based routing is a very useful technique, because cost may be defined in a manner that best achieves the needs of the network. In the present invention, the cost of an individual relay link may be defined, for example, as a function of intervening nodes' signal-strength measurements. Particularly, one embodiment utilizes a sum of all intervening nodes' signal strength measurements of a primary spectrum user, such that nodes with low summed received signal strength will have a low routing cost and nodes with high summed received signal strength will have a high routing cost. In this way, routes less likely to interfere with the primary spectrum user will be preferentially selected. Similarly, if all individual relay links have substantially the same received signal strength, and therefore the same cost, the route with the fewest relay links (and therefore requiring the fewest transmissions, and therefore least likely to cause interference to the primary user) will be preferentially selected.

Note that, since signal strength is a function of a node's distance to the primary spectrum user, distance may be used as a proxy for signal strength measurements. Nodes physically closer to a primary spectrum user may be assigned higher costs than nodes further away, so that routes employing nodes distant from the primary spectrum user will be preferentially selected. Thus, if the cost function comprises a sum of all intervening nodes' distances to a primary communication device, the step of determining the best route would comprise the step of determining a route with a greatest sum of all intervening nodes' distances to a primary spectrum user.

In a preferred embodiment of the present invention, to further protect a primary spectrum user a route may be declined by a node if its cost is above a threshold. The threshold may be predetermined, or calculated based on, for example, primary spectrum user received signal strength or an amount of recent transmission activity of the node or its neighbors. The threshold may be time-variable, so that nodes that have recently transmitted frequently will have lower route-rejection thresholds that increase over time. If the primary user is not continually active, the threshold can be high when its signal is not detected, then lowered upon its detection. Similarly, routing costs may also vary with time. Note that if the cost of the lowest-cost route is above the threshold, in order to protect the primary spectrum user, there will be no route available from source to destination. In this case, the route discovery procedure is performed by the source on the blocked destination from time to time, to identify routes that may become viable (i.e., with costs below the threshold) due to a change in the primary or secondary users or their environment.

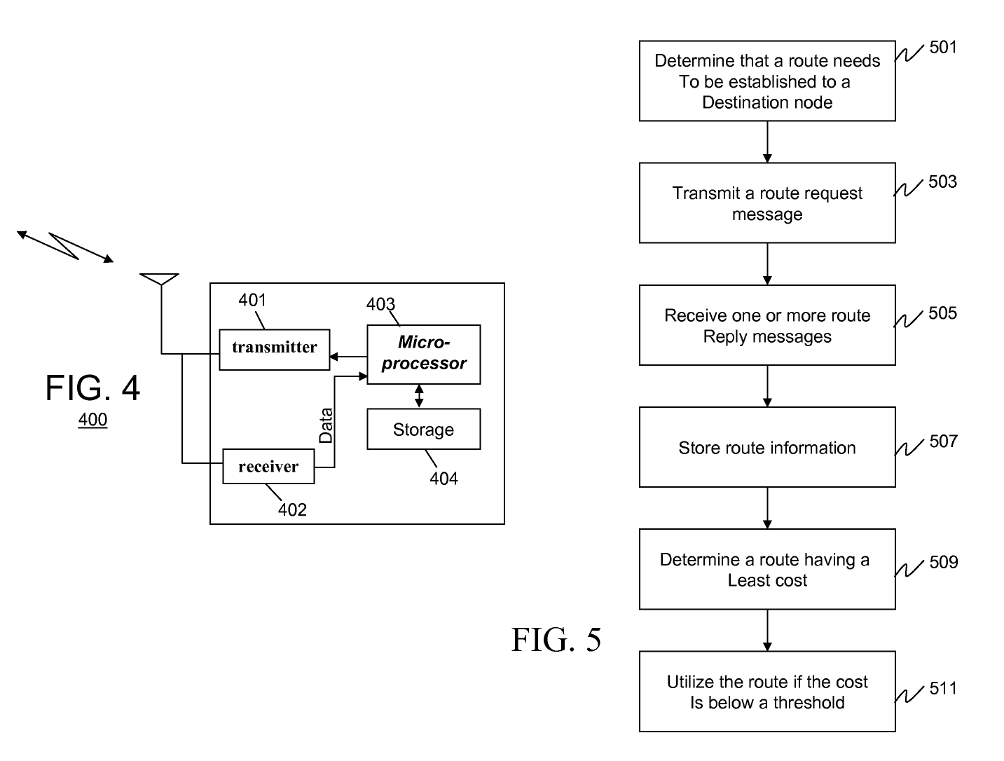

FIG. 4 is a block diagram a node 400 within secondary communication system 100. As shown, node 400 comprises transmit circuitry 401, receive circuitry 402, microprocessor (logic circuitry) 403, and storage 404. Logic circuitry 403 preferably comprises a microprocessor controller, such as, but not limited to a Freescale PowerPC microprocessor. In the preferred embodiment of the present invention logic circuitry 403 serves as means for controlling node 400, and as means for analyzing message content and determining a best route between nodes. Additionally receive and transmit circuitry are common circuitry known in the art for communication utilizing a well known communication protocol, and serve as means for transmitting and receiving messages. For example, receiver 402 and transmitter 401 are well known transmitters that utilize the 802.22 communication system protocol. Other possible transmitters and receivers include, but are not limited to transceivers utilizing Bluetooth, IEEE 802.11, or HyperLAN protocols. In the preferred embodiment of the present invention node 400 may serve as an originating node, an intervening node, or a destination node.

FIG. 5 is a flow chart showing the operation of a node of FIG. 2 when acting as an originating or source node. Those steps to determine a route to a destination node are described. The logic flow begins at step 501 where logic circuitry 403 determines that a route needs to be established from node 400 to a destination node. At step 503, microprocessor 403 initiates a route discovery algorithm by transmitting a RREQ message via transmitter 401 to neighboring nodes. In response, receiver 402 receives one or more RREP message(s) from the neighboring nodes, each containing a cost of a route to the destination node (step 505). Thus, at step 505 the costs of a plurality of possible routes to the destination node are received, one for each node from which a RREP message was received. At step 507, this information is stored in storage 404. Logic circuitry 403 then determines a cost of each route and selects a route having a least “cost” (step 509). As discussed above, the route having a least cost will preferably be the route that has a lowest combined signal strength measurements of the primary user and/or a least sum of intervening nodes' distance to a primary communication device. Each node within the route may measure the same, or differing primary users. The signal strength reported will be the greatest primary user signal strength detected by the node. If distances are utilized to determine a cost of the route, then each node will report the least distance to a primary node. Data transmissions then take place via transmitter 401 utilizing the determined route only if the cost of the route is below a threshold (step 511).

As is evident, the above logic flow results a best route being determined based on a function of intervening nodes' distance to a primary communication device and/or signal-strength measurements of the primary communication device.

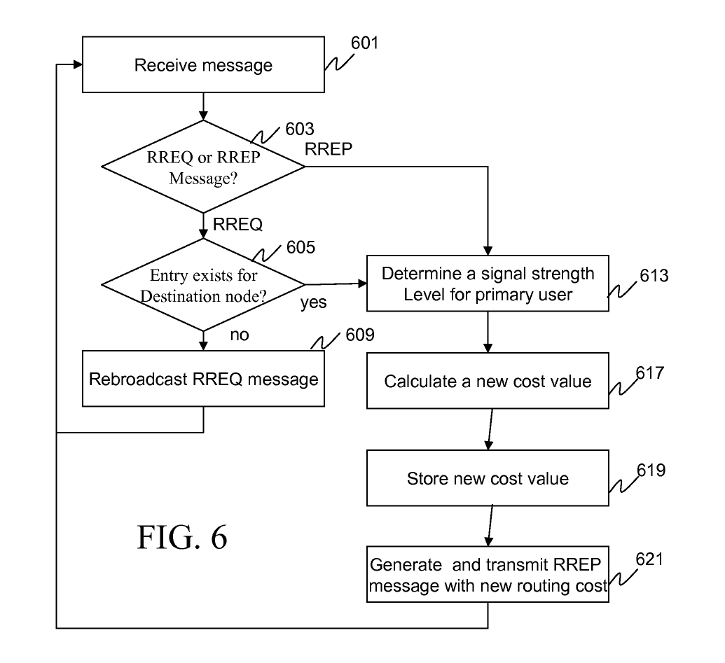

FIG. 6 is a flow chart showing the operation of a node of FIG. 2 when acting as a relay or a destination node. The logic flow begins at step 601 where a message (transmitted by another node in the network) is received by receiver 402. At step 603, logic circuitry 403 determines whether a RREQ or a RREP message was received. If a RREQ message was received, at step 605 logic circuitry 403 determines if the destination node has an entry in the routing table, stored in storage 404. If an entry is not present, at step 609, logic circuitry 403 instructs transmitter 401 to rebroadcast the received RREQ message and the logic flow returns to step 601. However, if an entry is present, the logic flow continues to step 613 where logic circuitry 403 instructs receiver 402 to determine a signal strength value for the primary spectrum user. At step 617, receiver 402 supplies a signal strength value to logic circuitry 403, which then uses this value, together with the routing cost value found in the routing table, to calculate a new routing cost value. At step 619, logic circuitry 403 stores this new value, indexed by the destination address received in the RREQ message, in the routing table in storage 404. At step 621, logic circuitry 403 generates a RREP message, containing the new routing cost value for the route to the destination node, and instructs transmitter 401 to transmit the RREP message to the source node and the logic flow returns to step 601.

If, at step 603, logic circuitry 403 determines that a RREP message was received, the logic flow continues to step 613 where logic circuitry 403 instructs receiver 402 to determine a signal strength value for the primary spectrum user. At step 617, receiver 402 supplies a signal strength value to logic circuitry 403, which then uses this value, together with the routing cost value found in the routing table, to calculate a new routing cost value. At step 619, logic circuitry 403 stores this new value, indexed by the destination address received in the RREQ message, in the routing table in storage 404. At step 621, logic circuitry 403 generates a RREP message, containing the new routing cost value for the route to the destination node, and instructs transmitter 401 to transmit the RREP message to the source node and the logic flow returns to step 601.

While the invention has been particularly shown and described with reference to a particular embodiment, it will be understood by those skilled in the art that various changes in form and details may be made therein without departing from the spirit and scope of the invention. For example, although the above description was given with a route being formed with multiple intervening nodes, one of ordinary skill in the art will recognize that the above technique may be applied to any two-way communications. During such a scenario, each user will determine an effect that both users' communications will have on the primary communication system. Communication will either be prevented or allowed based on both users' effect on the primary user of the spectrum. It is intended that such changes come within the scope of the following claims.

1. A method for communicating by a secondary communication device over spectrum utilized by a primary communication device, the method comprising the steps of:
selecting a best route to utilize based on a function of intervening nodes' distance to a primary communication device or signal-strength measurements of the primary communication device; and
utilizing the best route to transmit data to the destination node.

2. The method of claim 1 wherein the function comprises a sum of all intervening nodes' signal strength measurements of a primary spectrum user.

3. The method of claim 2 wherein the step of selecting the best route comprises the step of selecting a route with a least sum of all intervening nodes' signal strength measurements of the primary spectrum user.

4. The method of claim 1 wherein the function comprises a sum of all intervening nodes' distances to a primary spectrum user.

5. The method of claim 4 wherein the step of selecting the best route comprises the step of selecting a route with a greatest sum of all intervening nodes' distances to a primary spectrum user.

6. A method for communicating by a secondary communication device over spectrum utilized by a primary communication device, the method comprising the steps of:
selecting at least one route to a destination node using a cost, wherein the cost of the route is a function of intervening nodes' signal-strength measurements of a primary communication device; and
utilizing a route to the destination node having a least cost.

7. The method of claim 6 wherein the function comprises a sum of all intervening nodes' signal strength measurements of a primary spectrum user.

8. The method of claim 6 wherein the step of utilizing the route to the destination node further comprises the step of utilizing the route to the destination node only if the cost of the route is less than a threshold value.

9. The method of claim 8 wherein the cost of a route comprises a sum of all intervening nodes' signal strength measurements of a primary spectrum user.

10. The method of claim 6 wherein the step of utilizing the route comprises the step of transmitting to the destination node sharing the spectrum with primary incumbents.

11. A method comprising the steps of:
receiving a route reply (RREP) message, wherein the route reply message comprises a cost for a route, and wherein the cost for the route is a function of intervening nodes' signal-strength measurements of a primary spectrum user;
determining a signal strength measurement of the primary spectrum user;
modifying the cost of the route based on the signal strength measurement of the primary spectrum user; and
forwarding the modified RREP message.

12. An apparatus comprising:
logic circuitry selecting at least one route to a destination node using a cost, wherein the cost of the route is a function of intervening nodes' signal-strength measurements of a primary communication device; and
a transmitter utilizing a route to the destination node having a least cost.

13. The apparatus of claim 12 wherein the function comprises a sum of all intervening nodes' signal strength measurements of a primary spectrum user.

14. The apparatus of claim 12 wherein the transmitter utilizes the route to the destination node further comprises the step of utilizing the route to the destination node only if the cost of the route is less than a threshold value.

15. The apparatus of claim 14 wherein the cost of a route comprises a sum of all intervening nodes' signal strength measurements of a primary spectrum user.

16. The apparatus of claim 12 wherein the transmitter transmits to the destination node sharing the spectrum with primary incumbents.

17. An apparatus for communicating by a secondary communication device over spectrum utilized by a primary communication device, the apparatus comprising:
logic circuitry selecting a best route to utilize based on a function of intervening nodes' distance to a primary communication device and/or signal-strength measurements of the primary communication device; and
a transmitter utilizing the best route to transmit data to the destination node.

18. The apparatus of claim 17 wherein the function comprises a sum of all intervening nodes' signal strength measurements of a primary spectrum user.

19. The apparatus of claim 17 wherein the function comprises a sum of all intervening nodes' distances to a primary spectrum user.
